(19) United States
(12) Patent Application Publication
(10) Pub. No.: US 2018/0219237 A1
(43) Pub. Date: Aug. 2, 2018

(54) Fuel Cell Freeze Protection Device and System

(71) Applicant: Ford Motor Company, Dearborn, MI (US)

(72) Inventors: Furgan Zafar Shaikh, Troy, MI (US); Sunil Katragadda, Canton, MI (US); Andreas R. Schamel, Erftstadt-Kierdorf (DE); Brian Gillespey, Gregory, MI (US); William Frederick Sanderson, JR., Commerce Township, MI (US); Craig Michael Mathie, White Lake Township, MI (US); Matthew Riley, Ann Arbor, MI (US); Virgo W. Edwards, Commerce Township, MI (US)

(21) Appl. No.: 15/417,800

(22) Filed: Jan. 27, 2017

(51) Int. Cl. H01M 8/04223; H01M 8/04029; H01M 8/04007; H01M 8/04225; H01M 8/2465; H01M 8/04302; H01M 8/04701

(52) U.S. Cl. CPC H01M 8/04253; H01M 8/04029; H01M 8/04052; H01M 8/04723; H01M 8/2465; H01M 8/04302; H01M 8/04225

(57) ABSTRACT

A fuel cell system including a fuel cell stack, a coolant loop and a thermal battery. The coolant loop is configured to flow a coolant liquid therethrough. The thermal battery includes a phase change material configured to absorb heat generated by the fuel cell stack or coolant liquid and to latently store the heat during a first mode of operation the fuel cell system.

### TECHNICAL FIELD

The present disclosure relates to a fuel cell freeze protection device and system.

### BACKGROUND

One important consideration for the implementation of a proton exchange membrane fuel cell within an automobile is the ability of the fuel cell to perform upon rapid startup under low temperature ambient conditions, such as temperatures below the freezing point of water, e.g., 0° C. or lower. During a rapid startup of the fuel cell, water generation and water phase change may detrimentally impact the performance of the fuel cell. Moreover, water freezing into ice within the fuel cell between shutdown and startup could cause difficulty or failure at startup.

### SUMMARY

In one embodiment, a fuel cell system including a fuel cell stack, a coolant loop and a thermal battery is disclosed. The coolant loop is configured to flow a coolant liquid therethrough. The thermal battery includes a phase change material configured to absorb heat generated by the fuel cell stack or coolant liquid and to latently store the heat during a first mode of operation the fuel cell system.

In a second embodiment, a fuel cell system including a fuel cell stack, a coolant loop, a coolant heater and a thermal battery is disclosed. The coolant loop is configured to flow a coolant liquid therethrough. The thermal battery includes a phase change material configured to absorb heat generated by the fuel cell stack or coolant liquid and to latently store the heat during a first mode of operation the fuel cell system.

In a third embodiment, a fuel cell system including a fuel cell stack, an enclosure and a phase change material is disclosed. The enclosure at least partially encloses the fuel cell stack and defines a cavity between the fuel cell stack and the enclosure. The phase change material occupies at least a portion of the cavity and is configured to absorb heat generated by the fuel cell stack and to latently store the heat during a first mode of operation the fuel cell system.

### BRIEF DESCRIPTION OF THE DRAWINGS

FIG. 1 is a schematic of a prior art fuel cell system utilizing a coolant fluid to provide freeze protection during fuel cell startup under low temperature ambient conditions;

FIG. 2 is a schematic of a fuel cell system utilizing a coolant fluid to provide freeze protection during fuel cell startup under low temperature ambient conditions according to an embodiment of the present invention;

FIG. 3 is a schematic of a fuel cell system utilizing a coolant fluid to provide freeze protection during fuel cell startup under low temperature ambient conditions according to another embodiment of the present invention;

FIG. 4 is a perspective view of a prior art fuel cell stack; and

FIG. 5 is a perspective view of a fuel cell stack according to an embodiment of the present invention;

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

One important consideration for the implementation of a proton exchange membrane fuel cell within an automobile is the ability of the fuel cell to perform upon rapid startup under low temperature ambient conditions, such as temperatures below the freezing point of water, e.g., 0° C. or lower. During a rapid startup of the fuel cell, water generation and water phase change may detrimentally impact the performance of the fuel cell. Moreover, water freezing into ice within the fuel cell between shutdown and startup could cause difficulty or failure at startup.

Due to the density of water and ice at 0° C., there is an approximately 9% volume expansion when water freezes into ice at 0° C. This volume expansion generates internal stresses in a fuel cell stack. These internal stresses dissipate as the volume decreases due to melting of the ice due to relatively higher temperatures of the ambient environment and/or the operation of the fuel cell. The repeated generation and dissipation of these unbalanced, internal stresses in the fuel cell stack may cause damage to the fuel cell structure and performance of the fuel cell components. Repeated freeze and thaw cycles within the fuel cell stack may lead to performance decay and damage to the fuel cell stack, which could affect the long term durability of the fuel cell.

Additionally, the presence of ice in the flow fields of a fuel cell may inhibit or prevent reactant flow, starving the fuel cell of necessary chemical reactants. This could result in lower cell voltages and even cell reversals that could cause serious damage to fuel cell components. Water present in the catalyst layer may also freeze, blocking reactant sites and diminishing the active area of the fuel cell that can produce current, which could lead to low performance and potential failed startups.

Even if the fuel cell stack is kept above the freezing temperature of water, damage could occur if the fuel cell system is started with certain components of the cooling system below freezing, with the coolant fluid circulating through the fuel cell stack before it begins to produce heat. The cold coolant fluid may freeze the fuel cell stack from within it.

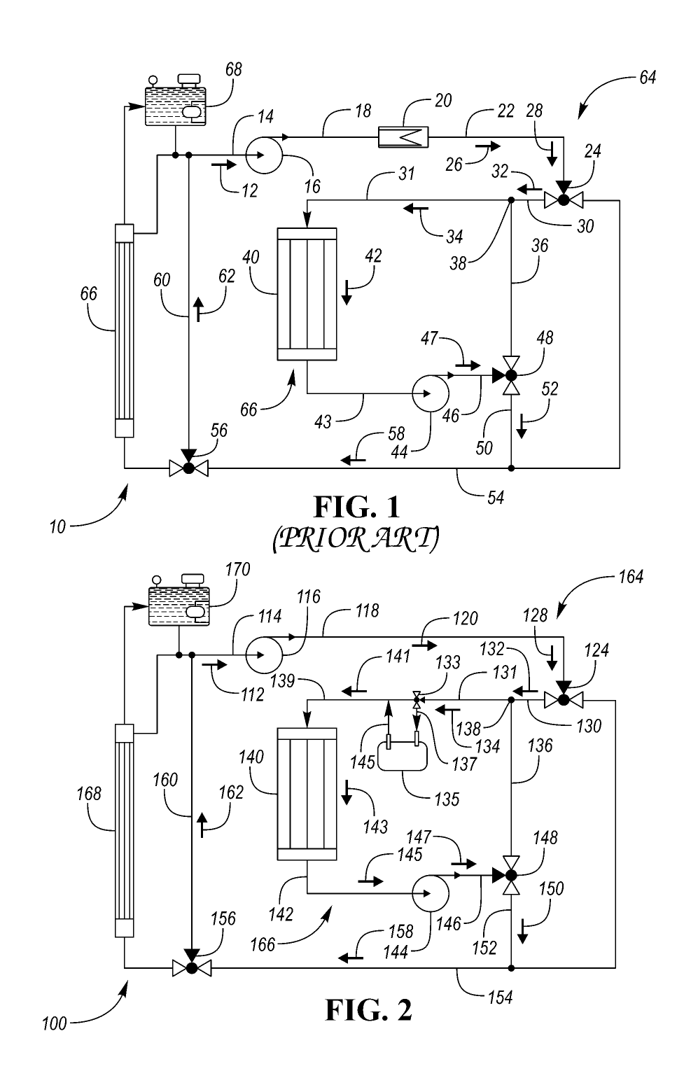

One current proposal to provide fuel cell freeze protection is to use a mixture of ethylene glycol and deionized water, e.g., a 50%/50% mixture, as a coolant fluid to provide freeze protection during a fuel cell startup under low temperature ambient conditions, e.g., 0° C. or lower. FIG. 1 is a schematic of prior art fuel cell system 10 utilizing a coolant fluid, e.g., a mixture of ethylene glycol and deionized water, to provide freeze protection during a fuel cell startup under low temperature ambient conditions, e.g., 0° C. or lower.

As shown by arrow 12 of FIG. 1, coolant fluid, e.g., a 50%/50% mixture of ethylene glycol and deionized water, flows through conduit 14 into electrical fluid pump 16. Electrical fluid pump 16 pumps coolant fluid into conduit 18. Due to the force of electrical fluid pump 16, the coolant fluid flows through conduit 18 into heater 20. Heater 20 requires power external fuel cell system 10 for operation.

The heated coolant fluid exits heater 20 through conduit 22 and flows towards and into three-way valve 24, as depicted by arrows 26 and 28. Three-way valve 24 directs the heated coolant fluid into conduit 30 and the heated coolant fluid flows through the conduits 30 and 31 towards fuel cell stack 40 as depicted by arrows 32 and 34, respectively. Conduits 30 and 31 form a three-way intersection 38 with conduit 36.

The heated coolant fluid enters fuel cell stack 40 and flows therethrough, as depicted by arrow 42. The heated coolant fluid exchanges heat with the water and/or ice residing in fuel cell stack 40. This heat exchange can be used to minimize or eliminate the formation of ice from water during the period between fuel cell stack shutdown and startup during low temperature ambient conditions. This heat exchange can also be used to melt ice formed during the period between fuel cell stack shutdown and startup during low temperature ambient conditions or in connection with a fuel cell startup under low temperature ambient conditions.

The heat-exchanged coolant fluid exits fuel cell stack 40 into conduit 43, which is connected to electrical fluid pump 44. Electrical fluid pump 44 pumps coolant fluid into conduit 46. Due to the force of electrical fluid pump 44, the coolant fluid flows through conduit 46 into three-way valve 48, as depicted by arrow 47. Three-way valve 48 directs the coolant fluid into conduit 50, as depicted by arrow 52. The coolant fluid flows through conduit 54 towards three-way valve 56, as depicted by arrow 58. Three-way valve 56 directs the coolant fluid through conduit 60 towards conduit 14, as depicted by arrow 62, which completes the circulation of the coolant fluid through fuel cell main loop 64 and fuel cell stack loop 66 of fuel cell system 10.

Radiator 66 dissipates heat generated by fuel cell stack 40 during high power output conditions of fuel cell stack 40 and under high load operation during high ambient temperatures. Degas bottle 68 allows entrained air and gases in coolant to be separated from the coolant as it flows through degas bottle 68. Degas bottle 68 may be physically separated from radiator 66 and closed by a pressure cap. Degas bottle 68 may be operated under an internal pressure of 15 PSI gauge and may be connected to radiator 66 and fuel cell stack 40 through the cooling loop and coolant thereby circulates through degas bottle 68.

In one embodiment of the present invention, a coolant heater is eliminated from the fuel cell system. The cost and power requirements of the fuel cell system can be reduced by eliminating the coolant heater. FIG. 2 is a schematic of fuel cell system 100 utilizing a coolant fluid, e.g., a mixture of ethylene glycol and deionized water, to provide freeze protection during fuel cell startup under low temperature ambient conditions, e.g., 0° C. or lower, according to one embodiment of the present invention.

As shown by arrow 112, coolant fluid, e.g., a 50%/50% mixture of ethylene glycol and deionized water, flows through conduit 114 into electrical fluid pump 116. Electrical fluid pump 116 pumps coolant fluid into conduit 118. Due to the force of electrical fluid pump 116, the coolant fluid flows through conduit 118 into three-way valve 124, as depicted by arrows 120 and 128. Three-way valve 124 directs the coolant fluid into conduits 130 and 131 towards three-way valve 133, as depicted by arrows 132 and 134, respectively. Conduits 130 and 131 form a three-way intersection 138 with conduit 136.

In one mode of operation, three-way valve 133 directs coolant fluid into thermal battery 135 through conduit 137. The coolant fluid exits thermal battery 135 through conduit 145. In one embodiment, this mode of operation is normal operation of fuel cell stack 140, e.g., after a startup of fuel cell system 100. During this mode of operation, thermal battery 135 stores energy released from the coolant fluid in the form of latent heat. This energy would otherwise be released to the environment as waste energy.

Thermal battery 135 may store the energy in a phase change material in the form of latent heat. For instance, the phase change material is in solid form at or near the beginning of normal operation of fuel cell stack 140. As the phase change material absorbs energy released from the coolant fluid, the phase change material starts and continues to change phase from solid to liquid, thereby storing latent heat within the phase change material. The phase change material melting point temperature can be selected to be compatible with the operating temperature range of fuel cell stack 140. This compatibility accounts for maximizing the amount of latent heat that can be stored by the phase change material based on the operating temperature range of fuel cell stack 140.

Non-limiting examples of phase change materials include organic, fluid and solid type phase change materials. The phase change material may have a melting temperature of any of the following temperatures or in a range of any two of the following temperatures: 0, 50, 100, 150, 200, 250, 300 and 350° C. The phase change material may have a latent heat capacity of any of the following heat capacities or in a range of any two of the following heat capacities: 100, 150, 200, 250, 300, 350 and 400 KJ/Kg. The operating temperature of fuel cell stack 140 may be any of the following temperatures or in a range of any two of the following temperatures: 70, 75, 80, 85 and 90° C. The operating temperature of coolant fluid may be any of the following temperatures or in a range of any two of the following temperatures: 85, 90 and 95° C.

A non-limiting example of an organic phase change material is RT100-Rubitherm phase change material available from Rubitherm GmbH. A non-limiting example of a fluid phase change material is water. Non-limiting examples of solid phase change materials are paraffin, erythritol, Sr(OH)₂*H₂0 and salts, such as NaNO₃. The RT100-Rubitherm phase change material has a phase change temperature of 100° C. and a latent heat capacity of 124 KJ/Kg. Water has a phase change material of 0° C. and a latent heat capacity of 334 KJ/Kg. Paraffin has a phase change temperature of 60° C. and a latent heat capacity of 220 KJ/Kg. NaNO₃ has a phase change temperature of 306° C. and a latent heat capacity of 114 KJ/Kg. Erythritol has a phase change temperature of 118° C. and a latent heat capacity of 349 KJ/Kg. Sr(OH)₂*H₂0 has a phase change temperature of 90° C. and a latent heat capacity of 375 KJ/Kg.

Thermal battery 135 may include an insulating layer at least partially enclosing the phase change material to retain the latent heat within the phase change material instead of the latent heat being released into the environment as waste energy. The insulating layer may be selected so that the phase change material (after absorbing coolant fluid energy in the form of latent heat) stays at or above its melting temperature for a pre-determined amount of time. The pre-determined amount of time may be any of the following times or in a range of any two of the following times: 10, 12, 14, 16, 18, 20, 22 and 24 hours. Non-limiting examples of insulating material include expanded polystyrene (EPS), mineral wool and polyurethane (PU) foam. Other non-limiting examples include super insulating materials (SIMs) such as vacuum insulation panels (VIP) and Aerogel-based products.

In a second mode of operation, three-way valve 133 opens to allow coolant fluid to be directed through conduit 139 and fuel cell stack 140, as represented by arrows 141 and 143, respectively. In one embodiment, the second mode of operation is startup during low temperature ambient conditions. Under such conditions, the flowing coolant fluid is heated by the latent heat of the phase change material that is in liquid form. The heated coolant fluid passes through fuel cell stack 140 to melt frozen water within fuel cell stack 140, which mitigates or eliminates a freeze condition. In one or more embodiment, the heated coolant fluid is delivered to fuel cell stack 140 substantially immediately after a cold startup of fuel cell system 140 in no greater then 60, 50, 40, 30, 20, 10, 5 or 1 second. In contrast, heater 20 needs time to heat up before delivering heated coolant fluid to fuel cell system 10. This time period may be one of the following or in a range of any two of the following: 240, 250, 260, 270, 280, 290, 300, 310 and 320 seconds.

The heated coolant fluid exchanges heat with the water and/or ice residing in fuel cell stack 140. This heat exchange can be used to minimize or eliminate formation of ice from water during the period between fuel cell stack shutdown and startup during low temperature ambient conditions. This heat exchange can also be used to melt ice formed during the period between fuel cell stack shutdown and startup during low ambient conditions or in connection with a fuel cell startup under low temperature ambient conditions.

The heat-exchanged coolant fluid exits fuel cell stack 140 into conduit 142 and is directed to electrical fluid pump 144, as depicted by arrow 145. Electrical liquid pump 144 pumps coolant fluid into conduit 146. Due to the force of electrical pump 144, the coolant fluid flows through conduit 146 into three-way valve 148, as depicted by arrow 147. Three-way valve 148 directs the coolant fluid into conduit 150, as depicted by arrow 158. Three-way valve 156 directs the coolant fluid through conduit 160 towards conduit 114, as depicted by arrow 162, which completes the circulation of the coolant fluid through fuel cell main loop 164 and fuel cell stack loop 166 of fuel cell system 100.

Radiator 168 dissipates heat generated by fuel cell stack 140 during high power output conditions of fuel cell stack 140 and under high load operation during high ambient temperatures. Degas bottle 170 allows entrained air and gases in coolant to be separated from the coolant as it flows through degas bottle 170. Degas bottle 170 may be physically separated from radiator 168 and closed by a pressure cap. Degas bottle 170 may be operated under an internal pressure of 15 PSI gauge and may be connected to radiator 168 and fuel cell stack 140 through the cooling loop and coolant thereby circulates through degas bottle 170.

As depicted in FIG. 2, the freeze protection proceeds through fuel cell main loop 164 and fuel cell stack loop 166 of fuel cell system 100. As shown in FIG. 2, thermal battery 135 is part of the fuel cell stack loop 166, although in other embodiments it may be part of the fuel cell main loop 164. The flow rate of the coolant fluid may be different between fuel cell main loop 164 and fuel cell stack loop 166. In one or more embodiments, three-way valves 124 and 148 are used to isolate fuel cell main loop 164 and fuel cell stack loop 166. This isolation allows the fuel cell stack loop 166 to be isolated from flow rate fluctuations between fuel cell main loop 164 and fuel cell stack loop 166.

In one or more embodiments, coolant fluid that is heated by the phase change material of thermal battery 135 can be used to provide heat to the cabin of a vehicle. Moreover, thermal battery 135 can be sized so that the phase change material under low temperature ambient conditions can heat the vehicle cabin.

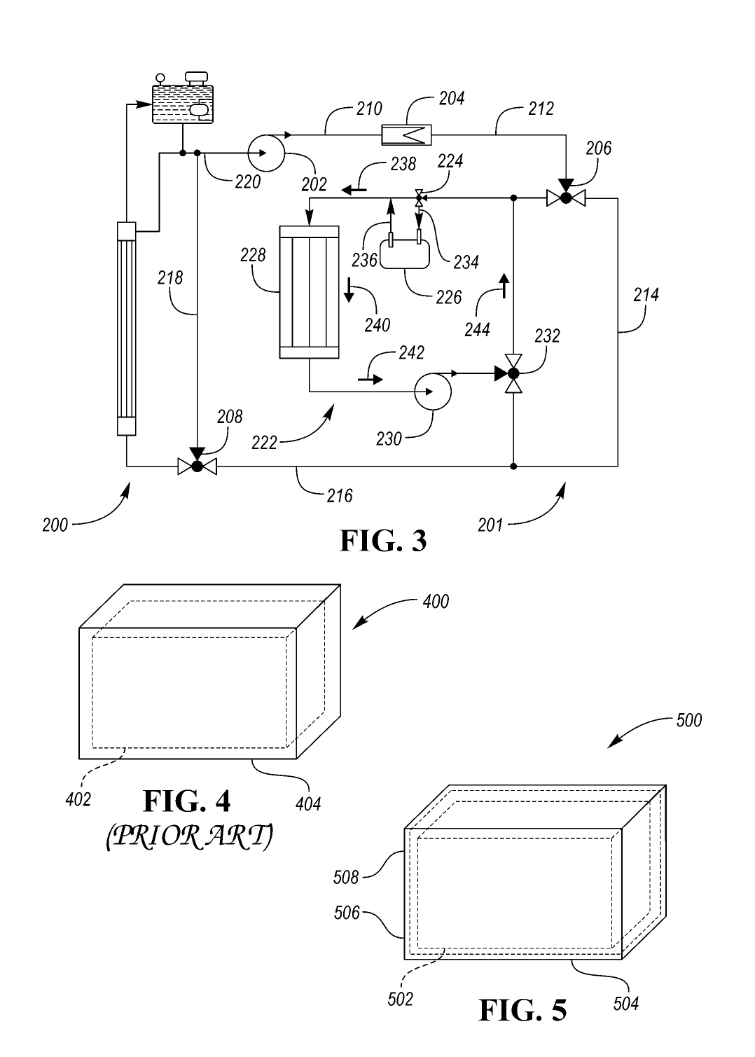

In one or more embodiments, a coolant heater and a thermal battery can be used within a fuel cell system. FIG. 3 is a schematic of fuel cell system 200 utilizing a coolant fluid, e.g., a mixture of ethylene glycol and deionized water, to provide freeze protection during fuel cell startup under low temperature ambient conditions, e.g., 0° C. or lower, according to one or more embodiments.

As shown in FIG. 3, main fuel cell loop 201 includes electrical fluid pump 202, heater 204, three-way valve 206 and three-way valve 208. Heater 20 may provide heat to increase the temperature of the coolant to increase the temperature of the fuel cell stack during startup under low ambient conditions. Heater 20 may also be utilized to provide heat to a vehicle cabin. The power of heater 20 may be selected based on the size of thermal battery 226. The power may be any of the following powers or in a range based on any two of the following powers: 1.5, 2.0, 2.5, 3.0, 3.5, 6.5, 10 and 15 kWs. Conduit 210 extends between electrical fluid pump 202 and heater 204 and is configured to deliver coolant fluid exiting electrical fluid pump 202 into heater 204, which heats coolant fluid. Conduit 212 extends between heater 204 and three-way valve 206 to deliver coolant fluid exiting heater 204 into three-way valve 206. Main fuel cell loop 201 also includes conduits 214, 216, 218 and 220 to deliver coolant fluid to electrical fluid pump 202.

Fuel cell stack loop 222 includes three-way valve 224, thermal battery 226, fuel cell stack 228, electrical fluid pump 230 and three-way valve 232. In one mode of operation, main fuel cell loop 201 and fuel cell stack loop 222 are open to each other. In this mode of operation, three-way valve 224 direct coolant fluid into thermal battery 226 through conduit 234. The coolant fluid exits thermal battery 226 through conduit 236. In one embodiment, this mode of operation is normal operation of fuel cell stack 228, e.g., after a startup of fuel cell system 200. During this mode of operation, thermal battery 226 stores energy released from the coolant fluid in the form of latent heat. This energy would otherwise be released to the environment as waste energy.

Thermal battery 226 may store the energy in a phase change material in the form of latent heat. For instance, the phase change material is in solid form at or near the beginning of normal operation of fuel cell stack 228. As the phase change material absorbs energy released from the coolant fluid, the phase change material starts and continues to change phase from solid to liquid, thereby storing latent heat within the phase change material.

In another mode of operation, fuel cell stack loop 222 is isolated from main fuel cell loop 201. In this mode, three-way valves 206 and 232 are closed to main fuel cell loop 201. Accordingly, coolant fluid only flows through fuel cell stack loop 222 as depicted by arrows 238, 240, 242 and 244. In one embodiment, the second mode of operation is startup during low temperature ambient conditions. Under such conditions, the flowing coolant fluid is heated by the latent heat of the phase change material that is in liquid form. The heated coolant fluid passes through fuel cell stack 228 to melt frozen water within fuel cell stack 228, which mitigates or eliminates a freeze condition. Moreover, while the heating coolant fluid is performing this function, heat generated by heater 204 can be utilized to supply heat to a vehicle cabin. Thermal battery 228 can be sized based on cost, weight and packaging consideration. In certain embodiments, the mass of thermal battery 228 can be any of the following or in a range of any two of the following: 2.0, 2.5, 3.0, 3.5, 4.0, 4.5, 5.0 and 10.0 kgs.

FIG. 4 is a perspective view of prior art fuel cell stack system 400. Fuel cell stack system 400 includes fuel cell stack 402 and stack enclosure 404 that fully encloses or at least partially encloses fuel cell stack 404.

In another embodiment, a fuel cell stack including a phase change material is disclosed. The phase change material can be used to thermally condition the fuel cell stack. FIG. 5 depicts a perspective view of integrated fuel cell stack system 500. Integrated fuel cell stack system 500 includes fuel cell stack 502 and stack enclosure 504 that fully encloses or at least partially encloses fuel cell stack 504. Stack enclosure 504 may include an insulating material 506. Non-limiting examples of insulating materials are expanded polystyrene (EPS), mineral wool and polyurethane (PU) foam. Other non-limiting examples include super insulating materials (SIMs) such as vacuum insulation panels (VIP) and Aerogel-based products.

In one or more embodiments, phase change material 508 is situated between fuel cell stack 502 and stack enclosure 504. Insulating material 506 is configured to aid in maintaining fuel cell stack 502 above the freezing temperature of water to reduce or eliminate the formation of ice between shutdown and startup the fuel cell system. Phase change material 508 is configured to have thermal properties which allow it to absorb and retain heat, thereby acting as an insulator of fuel cell stack 502 and a heater to heat the contents of fuel cell stack 502 during a cold startup scenario, for example. Phase change material 508 is configured to permit fuel cell stack 502 to retain its own heat and to add thermal mass to increase a thermal time constant. Phase change material is also configured to receive heat from fuel cell stack 502, vehicle heat waste source and/or from an external force. Phase change material 508 can partially fill or completely fill the volume between the stack enclosure 504 and fuel cell stack 502.

In one mode of operation of fuel cell stack 502, phase change material 508 melts to liquid by absorbing and storing a heat in the form of latent heat. This mode of operation may be normal operation of fuel cell stack 502, e.g., after a startup of the fuel cell system. In a second mode of operation, e.g., after shutdown, the liquid form of phase change material 508 cools down, starts to solidify and releases the absorbed heat. The liquid form of phase change material 508 exchanges heat with fuel cell stack 502, including water and/or ice residing in fuel call stack 502. This heat exchange can be used to minimize or eliminate formation of ice from water during the period between fuel cell stack shutdown and startup during low temperature ambient conditions. This heat exchange can also be used to melt ice formed during the period between fuel shutdown and startup during low ambient conditions or in connection with a fuel cell startup under low temperature ambient conditions.

As with fuel cell systems 100 and 200, integrated fuel cell stack 500 can be utilized to maintain a fuel cell stack at a more uniform temperature during operation of the fuel cell system. By maintaining enhance temperature uniformity, thermal stresses on the fuel cell stack may be reduces, thereby extending the durability and service life of the fuel cell stack.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A fuel cell system comprising:
a fuel cell stack;
a coolant loop configured to flow a coolant liquid therethrough; and
a thermal battery including a phase change material configured to absorb heat generated by the fuel cell stack or coolant liquid and to latently store the heat during a first mode of operation of the fuel cell system.

2. The fuel cell system of claim 1, wherein the phase change material is further configured to at least partially change phase from solid to liquid during the first mode of operation.

3. The fuel cell system of claim 1, wherein the phase change material is further configured to release latent heat into the fuel cell stack or coolant loop during a second mode of operation of the fuel cell system.

4. The fuel cell system of claim 3, wherein the phase change material is further configured to at least partially change phase from liquid to solid during the second mode of operation of the fuel cell system.

5. The fuel cell system of claim 1, wherein the first mode of operation is a normal operating mode of the fuel cell system.

6. The fuel cell system of claim 3, wherein the second mode of operation is a startup of the fuel cell system at low temperature ambient conditions of 0° C. or lower.

7. The fuel cell system of claim 5, wherein the fuel cell stack or coolant liquid is configured to release heat to the thermal battery during the first mode of operation.

8. The fuel cell system of claim 6, wherein the fuel cell stack or coolant liquid is configured to absorb heat from the thermal battery during the second mode of operation.

9. (canceled)

10. The fuel cell system of claim 1, wherein the thermal battery includes an insulating layer to at least partially enclose the thermal battery.

11-20. (canceled)

21. A fuel cell system comprising:
a fuel cell stack;
a coolant loop configured to flow a coolant liquid therethrough; and
a thermal battery including a phase change material configured to absorb heat generated by the fuel cell stack or coolant liquid, to latently store the heat during a first mode of operation of the fuel cell system, and to latently heat a volume external to the fuel cell system.

22. The fuel cell system of claim 21, wherein the phase change material is further configured to at least partially change phase from solid to liquid during the first mode of operation.

23. The fuel cell system of claim 21, wherein the phase change material is further configured to release latent heat into the fuel cell stack or coolant loop during a second mode of operation of the fuel cell system.

24. The fuel cell system of claim 23, wherein the phase change material is further configured to at least partially change phase from liquid to solid during the second mode of operation of the fuel cell system.

25. The fuel cell system of claim 21, wherein the first mode of operation is a normal operating mode of the fuel cell system.

26. A fuel cell system comprising:
a fuel cell stack;
a coolant loop configured to flow a coolant liquid therethrough;
a thermal battery including a phase change material configured to absorb heat generated by the fuel cell stack or coolant liquid, to latently store the heat during a first mode of operation of the fuel cell system, and to latently heat a volume external to the fuel cell system; and
a fuel cell stack loop including the fuel cell stack and the thermal battery.

27. The fuel cell system of claim 26, wherein the phase change material is further configured to at least partially change phase from solid to liquid during the first mode of operation.

28. The fuel cell system of claim 26, wherein the phase change material is further configured to release latent heat into the fuel cell stack or coolant loop during a second mode of operation of the fuel cell system.

29. The fuel cell system of claim 28, wherein the phase change material is further configured to at least partially change phase from liquid to solid during the second mode of operation of the fuel cell system.

30. The fuel cell system of claim 26, wherein the first mode of operation is a normal operating mode of the fuel cell system.

31. The fuel cell system of claim 28, wherein the second mode of operation is a startup of the fuel cell system at low temperature ambient conditions of 0° C. or lower.
